(19) United States
(12) Patent Application Publication
(10) Pub. No.: US 2016/0100917 A1
(43) Pub. Date: Apr. 14, 2016

(54) MOLDED DENTURE AND METHOD AND APPARATUS OF MAKING SAME

(71) Applicant: CMP INDUSTRIES LLC, Albany, NY (US)

(72) Inventor: Devon O. HOWE, Saratoga Springs, NY (US)

(73) Assignee: CMP INDUSTRIES LLC, Albany, NY (US)

(21) Appl. No.: 14/879,413

(22) Filed: Oct. 9, 2015

Related U.S. Application Data
(60) Provisional application No. 62/062,936, filed on Oct. 12, 2014.
(60) Provisional application No. 62/093,728, filed on Dec. 18, 2014.

(51) Int. Cl. A61C 13/00; A61C 13/34

(52) U.S. Cl. CPC A61C 13/0006; A61C 13/34; A61C 13/0004; B33Y 10/00

(57) ABSTRACT

A method for making a denture comprising creating three-dimensional models of top denture base, bottom denture base, and denture tooth molds; fabricating the molds by an additive manufacturing process; joining the bottom denture base mold to the top denture base mold to form a denture base mold cavity; injecting fluid synthetic denture base material into the mold cavity and curing the material to form the denture base; removing the bottom denture base mold from the top denture base mold, while leaving the denture base in the top denture base mold; joining the denture tooth mold to the top denture base mold to form a mold cavity defining the shape of denture teeth; and injecting fluid synthetic denture tooth material into the denture teeth mold cavity and curing the material to form the denture teeth joined to the denture base. An apparatus for making the denture is also disclosed.

### CROSS-REFERENCE TO RELATED PATENT APPLICATIONS

This application claims priority from U.S. Provisional Patent Application No. 62/062,936, filed Oct. 12, 2014; and further claims priority from U.S. Provisional Patent Application No. 62/093,728, filed Dec. 18, 2014. This application is also related to U.S. patent application Ser. No. 14/088,404, filed Nov. 24, 2013; U.S. patent application Ser. No. 14/180,260, filed Feb. 13, 2014; U.S. patent application Ser. No. 14/210,482, filed Mar. 14, 2014; U.S. patent application Ser. No. 14/212,532, filed Mar. 14, 2014; U.S. patent application Ser. No. 14/212,645, filed Mar. 14, 2014; and U.S. patent application Ser. No. 13/571,468, filed Aug. 10, 2012, and issued as U.S. Pat. No. 8,641,938 on Feb. 4, 2014. The disclosures of all of these United States patent applications are incorporated herein by reference.

### BACKGROUND

1. Technical Field

Dental prostheses and apparatus and methods of manufacturing them. In particular, computer-implemented methods of manufacturing dental prostheses, a computer-aided system for manufacturing dental prostheses, and dental prostheses made by the system and method.

2. Description of Related Art

Heretofore, the manufacturing of dental prostheses has been a highly labor intensive process requiring multiple fittings to a patient in need of them, and many steps that must be performed at the hands of skilled artisans. The dental prostheses may be a complete upper and/or lower set of prosthetic teeth and their mountings, i.e., dentures, or partial dentures, crowns, bridges, and the like.

By way of illustration, the following are the steps currently practiced in many “dental laboratories” for the fabrication of a conventional fixed dental prosthetic known as a crown:
1) A dentist prepares the tooth (or teeth) of a patient to be fitted with a fixed prosthetic by removing tooth structure that is decayed, or to allow for space needed by the prosthetic device.
2) An accurate impression of the patient's existing gums and prepared teeth is made by the dentist at the dentist's office.
3) Gypsum material is poured into the impression to form a model (replica) of the dentition to be treated.
4) Wax is typically used to make a coping (thin metal substructure) on the model.
5) Using the “lost wax technique,” the wax is invested (covered) by a phosphate investment material and then it is heated to burn out (remove) the wax, leaving a void in its place.
6) Metal is cast into the void created by the loss of wax to create a metal coping.
7) The metal coping is finished with grinding stones, and typically heat-treated.
8) Porcelain powder dispersed in water is painted onto the metal coping.
9) The porcelain is fired in a furnace to sinter it into a continuous hard coating, resulting in the finished crown.

It can be seen that in the above highly labor-intensive process, each of these steps introduces a potential for a processing error. Even the slightest error, such as the investment being too cool, or the powder/water ratio of the investment being incorrect, may cause the crown to fit too tightly in the patient's mouth, resulting in improper occlusion (upper and lower teeth engagement). The crown may thus have to be scrapped or reworked through at least one iteration of additional process steps at considerable cost to the patient, dentist, and/or manufacturing lab.

Currently, Computer Aided Design and Computer Aided Manufacturing (CAD/CAM) for “fixed” restorative dentistry has evolved to the point where a digital impression can now be made in the dentist's office and the entire process can be computer implemented. However, certain shortcomings still remain in fixed restorative dentistry as presently practiced. For example, subtle irregularities often found in anterior (front) teeth are difficult to replicate using CAD/CAM processes. Manual methods of making anterior fixed prosthetics enable unlimited aesthetic options, only limited by the creativity of the artisan (dental laboratory technician). Some CAD/CAM techniques involve the use of milling a monolithic block of ceramic that does not deliver optimal aesthetics (example: too opaque), especially for anterior applications. For example, most natural teeth exhibit translucency and subtle color variations. A common solution for this problem is for a dental technician to apply a stain and/or glaze of porcelain over the prosthetic made by CAD/CAM. However, this manual step may defeat the primary benefit of CAD/CAM: precise dimensional accuracy.

With regard to the manufacturing of removable dental prosthetics, such as dentures and partials, implementation of CAD/CAM has begun to occur. A key technology that is used in some CAD/CAM denture manufacturing applications is “fused deposition modeling” (FDM). In FDM, a computer-controlled machine builds a three dimensional part by ejecting microscopic droplets of material while repeatedly traversing in an x-y plane, building the part layer-by layer. In a sense, the machine “ink-jet prints” each layer, and hence FDM is also referred to as “3D printing.” The physical model is built according to a three-dimensional virtual model that is prepared using CAD software and uploaded to the FDM machine.

CAD/CAM systems have recently been developed and used for the fabrication of partial denture frameworks. One such system uses a “haptic” device, which mimics a waxing tool that is familiar to dental technicians. However, this system generates only a CAD replica in plastic (made by a 3D printer), which requires subsequent extensive processing to obtain a metal partial denture framework. Hence there are still many error-prone steps after the CAD replica is made that can result in a poorly-fitting partial denture framework.

There have been some efforts by major manufacturers of dental materials to make a system to produce a complete (full) denture by 3D printing. The system includes a three-dimensional scanner for scanning an impression, software for creating a three-dimensional model of the denture, and the fused deposition modeling equipment for “printing” the denture. However, the materials available to use in three-dimensional printers are neither as dense nor cross-linked like a normal plastic artificial tooth. Hence a problem remains with the resulting dentures because the denture teeth that are made with available 3D printing plastic materials are not sufficiently wear-resistant.

An alternative approach to denture fabrication is to first make a denture base using a milling machine, which may be computer controlled. Sockets are then milled by the machine into the denture base, and pre-fabricated artificial teeth are placed into the sockets. A problem with this approach is that most of the teeth must be adjusted to some extent to fit within the space required in order for the denture to properly occlude with the opposing arch of the opposing denture or the patients existing opposing teeth. Manual labor is required for the adjustment of teeth; therefore, the potential for errors is introduced into the manufacturing process.

Another problem with this method is that artificial teeth are not consistently sized. They are made from a molding process, with the molds being used for many years. Over the course of use, material from the wall of the mold wears away, resulting in a mold cavity increasing in size. Hence a tooth made from a mold that has been in service for ten years will be larger than a tooth made when the mold was new. Additionally, molds contain multiple cavities, and the wear is not necessarily uniform. Thus the combination of wear with time and non-uniform wear of a mold results in the production of teeth that vary dimensionally within any given tooth size that is intended to be produced using the mold. Moreover, in the denture fabrication marketplace, artificial teeth are returnable for credit. It therefore becomes highly probable that artificial teeth produced 20 years ago from a new mold are in circulation with teeth produced very recently from the same but now aged mold having different dimensions.

There is thus a problem in that the dimensional variation of artificial teeth is significant with respect to the dimensions of the sockets formed by the milling machine in which the teeth are to be fitted. The sockets must be milled sufficiently large so as to receive the largest tooth encountered within a given tooth size and shape (i.e. incisor, canine, molar, etc.), and countermeasures taken when the tooth is too small and does not fight tightly into its socket. One countermeasure is to use an acrylic repair resin to secure the teeth into position and to fill the gap(s), of various sizes that may be present around an undersized tooth.

However, this practice is undesirable. Additional labor is required for this step, which is costly and which is likely a manual process which can introduce potential errors to the denture fabrication. The risk of denture tooth “pop-outs” (debonding from the denture base) is more likely because the volume of bonding material is quite small relative to the conventional method of bonding denture teeth, and the bonding surface may be restricted to the circumference of the denture tooth which interfaces with the denture base (and limited bonding of the area of the tooth that opposes the occlusal surface because this area has been adjusted to rest on the “floor” of the socket). In the conventional approach, uncured denture base material surrounds the neck of the teeth and the area of the teeth that oppose the occlusal surface and chemical bonds are formed due to the volume of material and time that the uncured material is allowed to form cross-linked chemical bonds with the artificial teeth.

In addition, like the conventional approach, the patient will not see the final configuration of the denture until the delivery appointment, at which time the patient may reject the denture based on aesthetics.

A further reason that “pop-outs” will be more likely with this approach vs. the conventional approach is that the conventional approach relies on a dental technician to adjust each artificial tooth in a way to optimize retention. For example, a dental technician will remove the “glaze” from a denture tooth (shiny and hard surface of the tooth created from a metal mold) to form a better bond with the denture base. Also, “diatoric” holes are often cut into the bottom or side of the tooth, or both, to allow acrylic material to flow in an optimal path to increase the surface area and create mechanical retention in a tooth. The step to provide diatoric holes is yet another processing step that increases cost and introduces the potential for further errors, such as artificial tooth fracture.

Yet another approach to denture fabrication is to mill blocks of polymerized plastic to make a complete denture. This process involves milling a block of pink methacrylate material as the denture base (including the gingiva surrounding the teeth). The teeth are then milled from a single piece of plastic. Lastly, the pink denture base and the milled teeth are cemented together. This technique is useful to make an immediate denture for temporary use, such as after a tooth-extraction for use while the gums heal. However, it is not suitable for long-term dentures because the artificial teeth made in this manner look unaesthetic. Natural dentition has subtle color (hue) variations as well as translucencies, color volume and defects. These effects are provided in most artificial teeth, which are generally made in two to four layers of overlapping material (plastic or porcelain), each layer having different shades and levels of translucency. These layers create a natural effect of tooth structure, especially in anterior (front) teeth which often display “mamelons” and translucent incisal edges.

Artificial teeth that have an aesthetically pleasing appearance are generally made of highly cross-linked polymethylmethacrylate plastic, but may also be made of porcelain. Such artificial teeth are made with a series of metal dies in which the teeth are formed one-layer at a time. When all of the layers are completed, the “green” tooth is then heated to polymerize the plastic (or super-heated in the case of porcelain teeth). The heating process completes the cross-linking process in plastic teeth to make the teeth resistant to wear from the forces of mastication. This process is not compatible with the above overall denture fabrication process in which the full set of teeth are milled from a single piece of plastic and bonded to the milled denture base.

U.S. Pat. No. 8,641,938, at present commonly owned by the Applicant, discloses manufacturing a denture by starting with a disc of pink denture base acrylic, then milling cavities for artificial teeth, then adding liquid artificial tooth acrylic into the prepared cavities and curing the material, then milling away unnecessary tooth and denture base material. One aspect of this technique is that the milling steps require significant time because the geometry to be milled is intricate and tolerances must be held to tight standards. In addition, many lower cost desktop mills do not have the speed or reach to cut-away the unneeded material efficiently.

In summary, there remains a need for a method and apparatus for fabricating a denture at low cost in a minimal number of steps and with minimal manual labor, and preferably at a single manufacturing station. A denture made by any such method and apparatus must be made with sufficient precision so as to fit the patient properly, and have teeth that are firmly retained, wear resistant, and aesthetically pleasing.

### SUMMARY

In accordance with the present disclosure, the problem of fabricating a denture at low cost in a minimal number of steps and with minimal manual labor is solved by printing a series of molds using CAD (computer aided design) systems, made with “fused deposition modeling” (FDM). In FDM, a computer-controlled machine builds a three dimensional part by ejecting microscopic droplets of material while repeatedly traversing in an x-y plane, building the part layer-by layer. In a sense, the machine “ink-jet prints” each layer, and hence FDM is also referred to as “3D printing.” The physical model is built according to a three-dimensional virtual model that is prepared using CAD software and uploaded to the FDM machine.

In accordance with the present disclosure, a method making a denture comprised of a base and a plurality of teeth joined to the base may include the following steps: creating three-dimensional models of a top denture base mold, a bottom denture base mold, and a denture tooth mold; fabricating the top and bottom denture base molds, and the denture tooth mold; removably joining the bottom denture base mold to the top denture base mold to form a mold cavity defining the shape of the denture base; injecting fluid synthetic denture base material into the denture base mold cavity and curing the denture base material to form the denture base; removing the bottom denture base mold from the top denture base mold, while leaving the denture base in the top denture base mold; removably joining the denture tooth mold to the top denture base mold to form a mold cavity defining the shape of denture teeth; and injecting fluid synthetic denture tooth material into the denture teeth mold cavity and curing the denture tooth material to form the denture teeth joined to the denture base; and removing the denture tooth mold from the top denture base mold, while leaving the denture base and denture teeth in the top denture base mold. In an embodiment in which the denture to be fabricated is comprised of a denture base and denture teeth of a single synthetic tooth material, the method further comprises removing the denture base and denture teeth joined together as the denture. In certain embodiments, the curing the fluid synthetic denture base material and/or curing the fluid synthetic denture tooth material may be performed by heating the fluid synthetic material(s). In other embodiments, the curing the fluid synthetic denture base material and/or curing the fluid synthetic denture tooth material may be performed by self-curing the fluid synthetic material(s).

In an embodiment in which the denture to be fabricated is comprised of a denture base and denture teeth of a synthetic tooth material and a synthetic enamel material, the method is further comprised of creating a three-dimensional model of a denture enamel mold, fabricating the denture enamel mold, removably joining the denture enamel mold to the top denture base mold to form a mold cavity defining the shape of denture enamel on the denture teeth; injecting fluid synthetic denture tooth enamel material into the denture teeth enamel cavity and curing the denture tooth enamel material to form the denture enamel joined to the denture teeth; and removing the denture tooth enamel mold from the top denture base mold, and removing the denture base, denture teeth, and denture tooth enamel joined together as the denture.

The method may further comprise removing molding sprues from the denture and polishing the denture base and the denture enamel to produce a finished denture. The top denture base mold, the bottom denture base mold, the denture tooth mold, and the denture enamel mold may be made by at least one additive manufacturing process.

For any one or more of the fluid synthetic denture base material, the fluid synthetic denture tooth material and the fluid synthetic denture enamel material, the curing may be done by heating the material. Alternatively, any of the fluid synthetic denture materials may be provided as self-curing materials, wherein the materials self-cure from a fluid phase to a solid phase.

In certain embodiments in which the denture is comprised of a denture base and a plurality of denture teeth, the apparatus may be comprised of a top denture base mold, a bottom denture base mold, a denture tooth mold, a fluid synthetic denture base material delivery device, and a fluid synthetic denture tooth material delivery device.

The bottom denture base mold is joinable to the top denture base mold to form a mold cavity therebetween defining the shape of the denture base. The fluid synthetic denture base material delivery device is configured to deliver fluid synthetic denture base material into the denture base mold cavity, which may then be cured to form the solid denture base. The bottom denture base mold is removable such that it may then be removed from the top denture base mold after denture base curing.

The denture tooth mold is joinable to the top denture base mold to form a tooth mold cavity defining the shape of the denture teeth therebetween when the denture base is disposed in the top denture base mold. The fluid synthetic denture tooth material delivery device is configured to deliver fluid synthetic denture tooth material into the denture tooth mold cavity, which fluid tooth material may then be cured to form the solid denture teeth. The denture tooth mold is removable such that it may then be removed from the top denture base mold after denture tooth curing.

In certain embodiments in which the denture to be fabricated is further comprised of tooth enamel material bonded to the denture tooth material, the apparatus may be further comprised of a denture enamel mold that is joinable to the top denture base mold to form an enamel mold cavity defining the shape of the denture enamel therebetween when the denture base is disposed in the top denture base mold and the denture teeth are joined to the denture base. The fluid synthetic denture enamel material delivery device is configured to deliver fluid synthetic denture enamel material into the denture enamel mold cavity, which fluid enamel material may then be cured to form the solid denture enamel bonded to the denture teeth. The denture enamel mold is removable such that it may then be removed from the top denture base mold after denture enamel curing.

The apparatus may include further comprising a fixture for holding the top denture base mold, and for removably joining a sequence of the bottom denture base mold, the denture tooth mold, and the denture enamel mold to the top denture base mold during the steps of denture fabrication. The apparatus may include a curing device configured to cure at least one of fluid synthetic denture base material, fluid synthetic denture tooth material, or fluid synthetic denture enamel material into a solid denture material.

In accordance with the present disclosure, there is also provided a kit for making a denture comprised of a denture base and a plurality of teeth joined to the base. The kit may be comprised of a top denture base mold, a bottom denture base mold, and a denture tooth mold. In using the kit, the bottom denture base mold is joinable to the top denture base mold to form a mold cavity therebetween defining the shape of the denture base, and the bottom denture base mold is removable from the top denture base mold after the denture base has been molded in the denture base mold cavity. Additionally, the denture tooth mold is joinable to the top denture base mold to form a tooth mold cavity defining the shape of the denture teeth therebetween when the denture base is disposed in the top denture base mold. The denture tooth mold is removable from the top denture base mold after the denture teeth have been molded in the denture tooth mold cavity.

In embodiments in which the denture includes denture teeth having an exterior layer of denture enamel, the kit may be further comprised of a denture enamel mold that is joinable to the top denture base mold to form an enamel mold cavity defining the shape of the denture enamel therebetween when the denture base is disposed in the top denture base mold and the denture teeth are joined to the denture base. The denture enamel mold is removable from the top denture base mold after the denture enamel has been molded in the denture tooth enamel cavity on the denture teeth.

In certain embodiments, the top denture base mold, the bottom denture base mold, the denture tooth mold, and the denture enamel mold are made by at least one additive manufacturing process. The additive manufacturing process may be selected from fused deposition modeling, selective laser melting, selective laser sintering, selective heat sintering, stereolithography, robocasting, electron beam freeform fabrication, direct metal laser sintering, electron bean melting, binder jetting, and digital light processing.

Also in accordance with the present disclosure, a denture comprised of a base and a plurality of teeth joined to the base is provided. The teeth are comprised of a molded inner region (first layer) of a first solid synthetic tooth material and a molded outer region (second layer) of a second solid synthetic tooth material. The second solid synthetic tooth material preferably has the appearance to an observer of natural teeth, i.e. the appearance of tooth enamel. The teeth may be further comprised of a third solid synthetic tooth material in an interior region between the first solid synthetic tooth material and the second solid synthetic tooth material, as disclosed in the Applicant's commonly owned U.S. Pat. No. 8,641,938.

As a result of the Applicant's method and apparatus, certain benefits in the manufacturing of dentures are realized. The requirement for skilled manual labor in fabrication is virtually eliminated. The opportunity to use computer control over all steps of fabrication also eliminates many errors, as well as making the process highly versatile. Via the use of software, a dental professional may create any shape and color of teeth to match the clinical and aesthetic needs of the patient, and the method and apparatus can be employed to make them to order. In addition, a dentist can show the patient a digital photo of his/her face with his/her new dentures, before the start of the fabrication process, thereby increasing the likelihood of patient acceptance of the denture at the delivery appointment. The manual expertise formerly required for tooth set-up in the denture is no longer needed, because such set-up can be predetermined using CAD software, and a digital three dimensional model of the denture uploaded to the computer-controlled fabrication apparatus such as FDM.

Additionally, the need for a dental lab to maintain a large stock of denture teeth is also eliminated. This is a significant cost savings, in that some dental labs maintain over $100,000 worth of teeth in their inventory in order to be able to timely satisfy incoming orders. In addition, handling costs of a large tooth inventory can be eliminated: shipping costs, ordering and stocking/retrieving costs, risk of theft/damage, cost of handling returns of partially used sets of teeth, etc. Furthermore, the shades, shapes, anatomy, imperfections, translucency, etc. of the teeth can be custom-made for each denture.

If it is desirable to fabricate a temporary “try-in” denture, this can be done by using a wax interface between denture teeth and denture base. The method and apparatus can be used to fabricate the try-in denture as described herein, but using a wax material as an interface between the teeth. Because of the wax interface between synthetic teeth and denture base, a dentist can fit the try-in denture to the patient, and make final adjustments to optimize the occlusion and aesthetics of the teeth. Then the final-adjusted try-in denture can be scanned in 3D and digitally compared to the original “wax try-in denture” and/or used as the source of a new three-dimensional denture model to be used in manufacturing the long term denture as described herein. In that manner, the final denture will have optimal fit to the patient, with only one fitting session needed with him/her before the final denture is delivered and fitted.

It is also noted that in manufacturing a denture according to the instant method, the artificial teeth are chemically bonded to the denture base on all surfaces which the artificial teeth interface with the denture base. This significantly reduces the likelihood of the artificial teeth detaching from the denture base (referred as a “pop-out”), and the formation of dark demarcation lines around the junction of the artificial teeth and artificial gingiva due to bacterial growth. (The latter problem is often found in dentures made with porcelain artificial teeth because there is no chemical bond between the denture base and the teeth.) Accordingly, the artificial teeth made by the present method and apparatus will look more natural.

### BRIEF DESCRIPTION OF THE DRAWINGS

The present disclosure will be provided with reference to the following drawings, in which like numerals refer to like elements, and in which:

FIG. 1A is a posterior perspective view of a denture base of a denture, including unoccupied sockets into which artificial denture teeth may be bonded;

FIG. 1B is an anterior perspective view of a denture base including unoccupied sockets into which artificial denture teeth may be bonded;

FIG. 2A is a side cross-sectional view of a bottom mold for making the denture base of FIGS. 1A and 1B, including the denture base to be made shown in dotted line format;

FIG. 2B is a perspective view of the bottom mold of FIG. 2A;

FIG. 2C is a top view of the bottom mold of FIG. 2A;

FIG. 3A is a side cross-sectional view of a bottom mold for making the denture base of FIGS. 1A and 1B, including the denture base to be made shown in dotted line format;

FIG. 3B is a perspective view of the top mold of FIG. 3A;

FIG. 3C is a bottom view of the top mold of FIG. 2A;

FIG. 4 is a side cross-sectional view of the top and bottom molds of FIGS. 2A and 2B shown joined together in preparation for molding the denture base of FIGS. 1A and 1B;

FIG. 5 is a side cross-sectional view depicting the molding and curing of the denture base in the mold cavity formed between the joined top and bottom molds of FIGS. 2A and 2B;

FIG. 6 is a side cross-sectional view of the top mold of FIG. 3A with bottom mold of FIG. 2A having been removed therefrom, and the molded denture base remaining adhered thereto;

FIG. 7 is a side cross-sectional view of a “rough” denture base shown removed from the top mold of FIG. 3A and ready for further molding and bonding of denture teeth thereto;

FIG. 8 is a side cross-sectional view of a first tooth body mold for making at least a first portion the denture teeth of the denture;

FIG. 9 is a side cross-sectional view of a top mold joined to the first tooth body mold of FIG. 8 in preparation for molding at least the first portion the denture teeth of the denture;

FIG. 10 is a side cross-sectional view depicting the molding and curing of at least the first portion the denture teeth in the mold cavity formed between the joined top and first tooth body molds;

FIG. 11 is a perspective schematic view of the denture base shown without the top and first tooth body molds, and indicating the flow of synthetic fluid tooth material relative to the denture base during the tooth molding process;

FIG. 12 is a side cross-sectional view of the top mold of FIGS. 9 and 10 with the first tooth body mold of FIGS. 9 and 10 having been removed therefrom, and the molded denture base with partially formed denture teeth remaining adhered thereto;

FIG. 13 is a side cross-sectional view of a second tooth body mold for making a second portion the denture teeth of the denture;

FIG. 14 is a side cross-sectional view of a top mold joined to the second tooth body mold of FIG. 13 in preparation for molding the second portion the denture teeth of the denture;

FIG. 15 is a side cross-sectional view depicting the molding and curing of at the second portion the denture teeth in the mold cavity formed between the joined top and second tooth body molds;

FIG. 16 is a side cross-sectional view of the top mold with the second tooth body mold of FIGS. 14-15 having been removed therefrom, and the molded denture base with the formed denture teeth remaining adhered thereto;

FIG. 17 is a side cross-sectional view of the unfinished denture comprising the denture base and denture teeth with the top mold of FIG. 16 having been removed therefrom;

FIG. 18A is a perspective view of a finished denture following removal of the denture from the molds, and subsequent deburring and polishing; and

FIG. 18B is a side cross-sectional view of the finished denture, taken along line 18B-18B of FIG. 18A.

### DETAILED DESCRIPTION

The present invention will be described in connection with certain preferred embodiments. However, it is to be understood that there is no intent to limit the invention to the embodiments described. On the contrary, the intent is to cover all alternatives, modifications, and equivalents as may be included within the spirit and scope of the invention as defined by the appended claims.

For a general understanding of the present invention, reference is made to the drawings. In the drawings, like reference numerals have been used throughout to designate identical elements. The drawings are to be considered exemplary, and are for purposes of illustration only. The dimensions, positions, order and relative sizes reflected in the drawings attached hereto may vary.

It is also to be understood that any connection references used herein (e.g., attached, coupled, connected, joined) are to be construed broadly and may include intermediate elements and/or materials between at least two elements unless otherwise indicated. As such, connection references do not necessarily imply that two elements are directly connected and in fixed relation to each other.

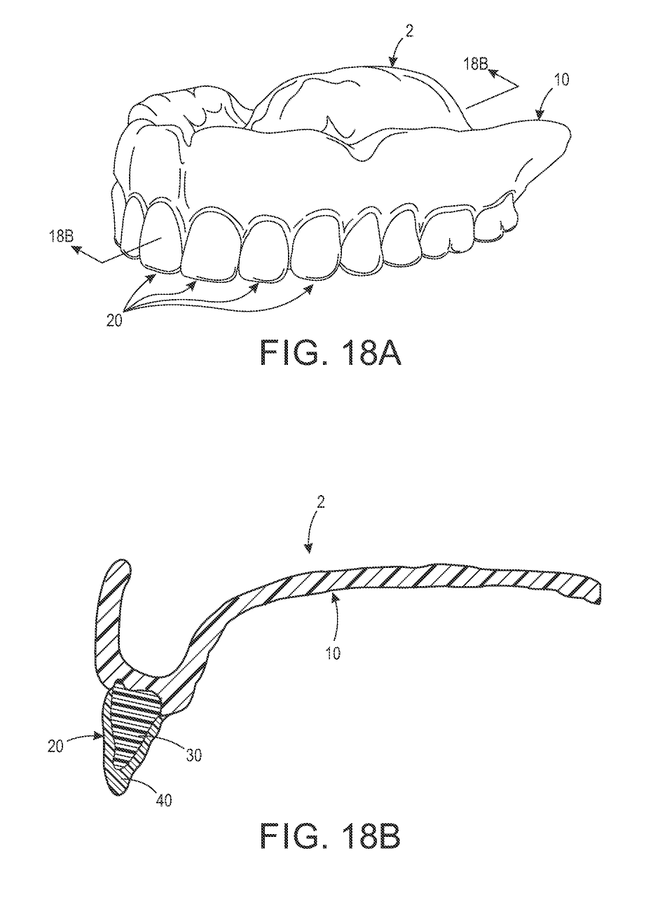

Turning now to the present method and apparatus for making a denture, exemplary embodiments of which are depicted in the drawings, the two main operations in making a denture are the molding of the denture base, and the molding of the denture teeth with bonding of the teeth to the denture base. FIGS. 18A and 18B depict perspective and side cross-sectional views, respectively, of a finished denture to be made using the present method and apparatus. The denture 2 is comprised of a denture base 10 and denture teeth 20. The denture teeth 20 may be comprised of first synthetic tooth material 30 and second synthetic tooth material 40. The first synthetic tooth material 30 may form an internal body layer, and the second synthetic tooth material 40 may form an enamel layer. The enamel layer preferably is formulated to provide a translucent appearance with subtle shade variations. In that manner, the denture teeth 20 have the desired aesthetic appearance of natural teeth.

Prior to using the Applicant's denture manufacturing apparatus to performing the Applicant's method, for a given patient who needs a denture, the denture must first be designed. The denture 2 may be designed using three-dimensional CAD design software, which produces a three-dimensional model of the denture 2, including three-dimensional models of the denture base 10 and the denture teeth 20. The three-dimensional models are based upon measurements of the patient's mouth and existing teeth and/or gums made by a dentist or dental technician, to ensure that the manufactured fits properly. The three-dimensional models of the denture base 10 and the denture teeth 20 may then be used as the basis for producing molds for fabrication of the denture base 10 and denture teeth 20 using 3D CAD design software.

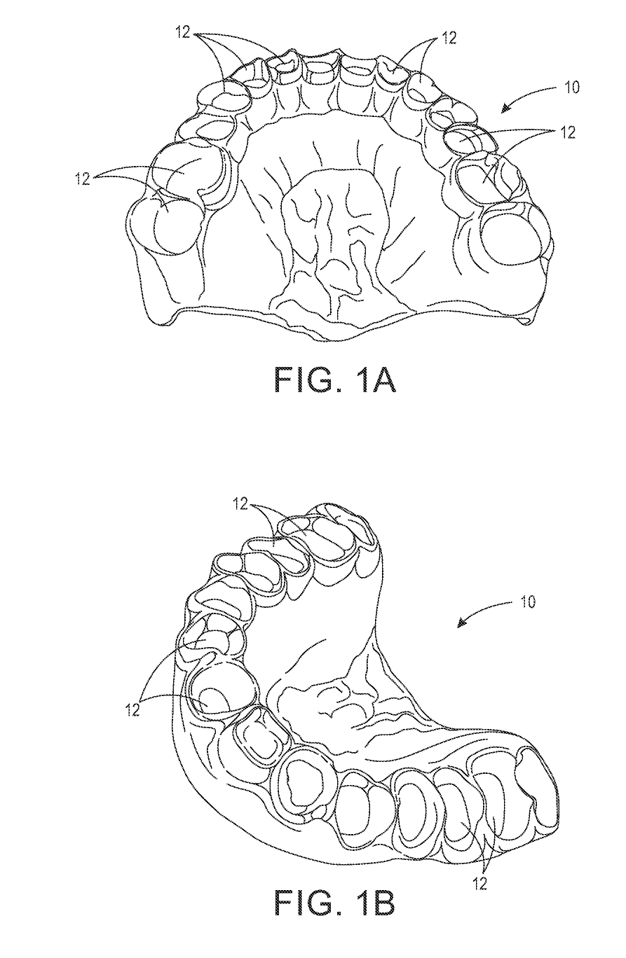

FIG. 1A and FIG. 1B depict respective posterior and anterior perspective views of the denture base 10 to be molded in the base molding operation. The denture base 10 includes sockets 12, into which the denture teeth 20 are to be molded and bonded in the teeth molding operation.

In order to mold the denture base, three-dimensional models of bottom and top denture base molds are produced using 3D CAD design software. In certain embodiments, the top and bottom molds may be made using an additive manufacturing process such as “fused deposition modeling” (FDM) process, also known as “3D printing.” In that manner, these custom made “one of a kind” molds for making a denture to fit a specific patient may be made at low cost. The top and bottom molds will likely be used only once, or at most a few times if the patient loses his/her denture, and a replacement denture is needed.

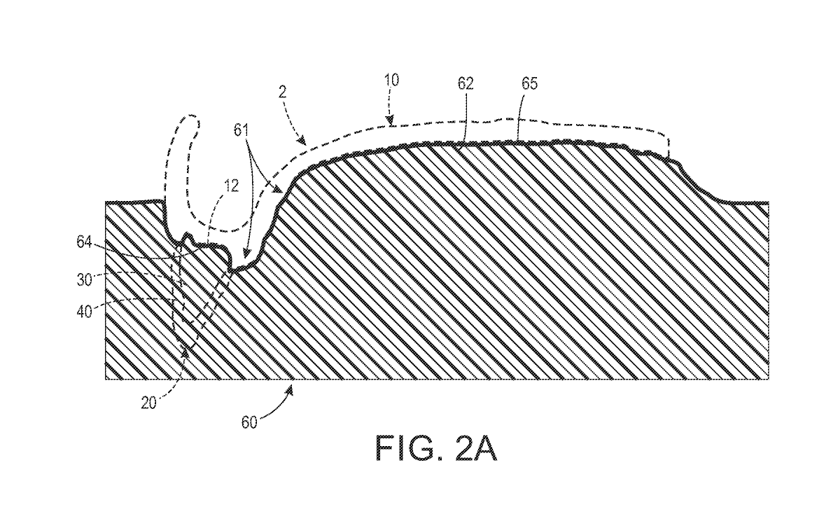

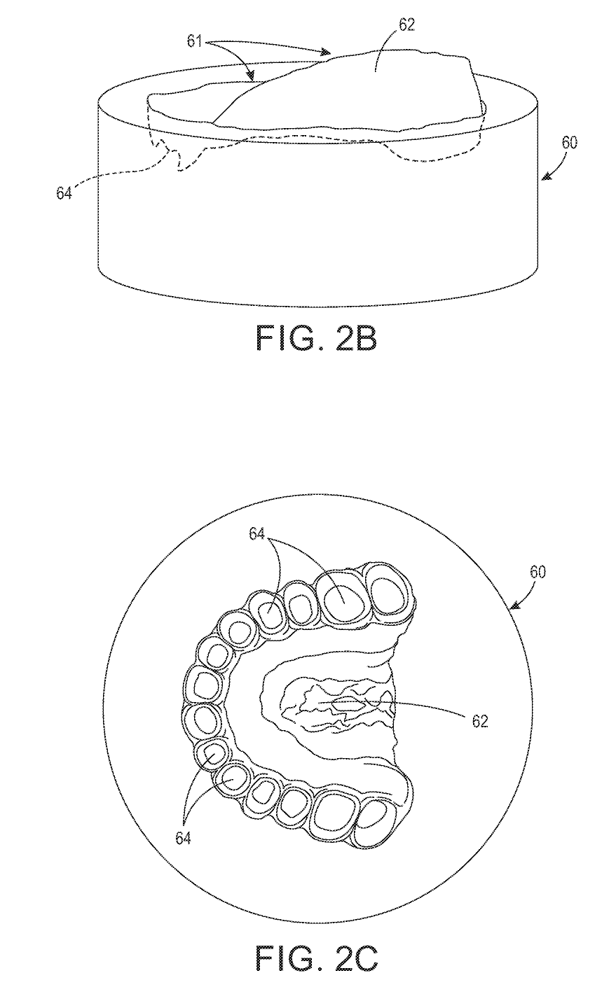

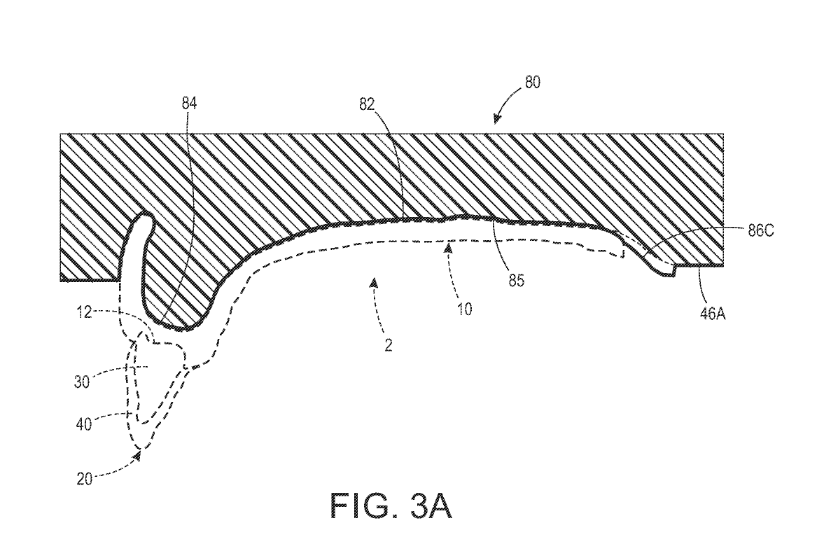

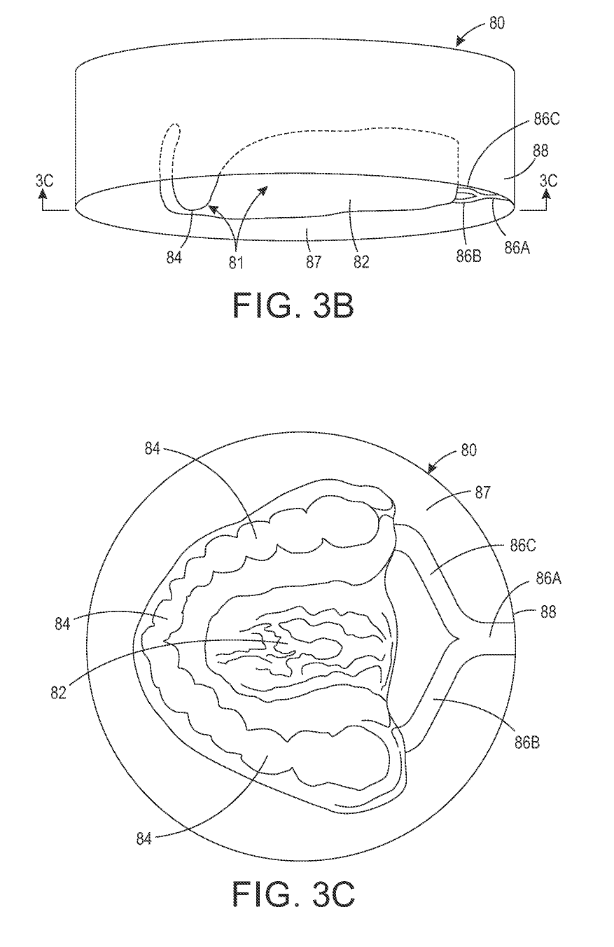

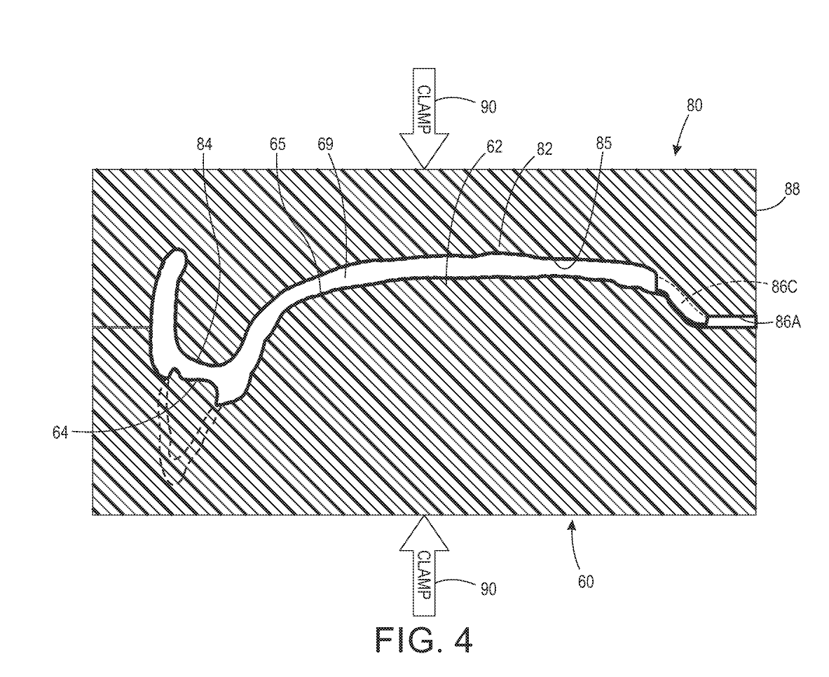

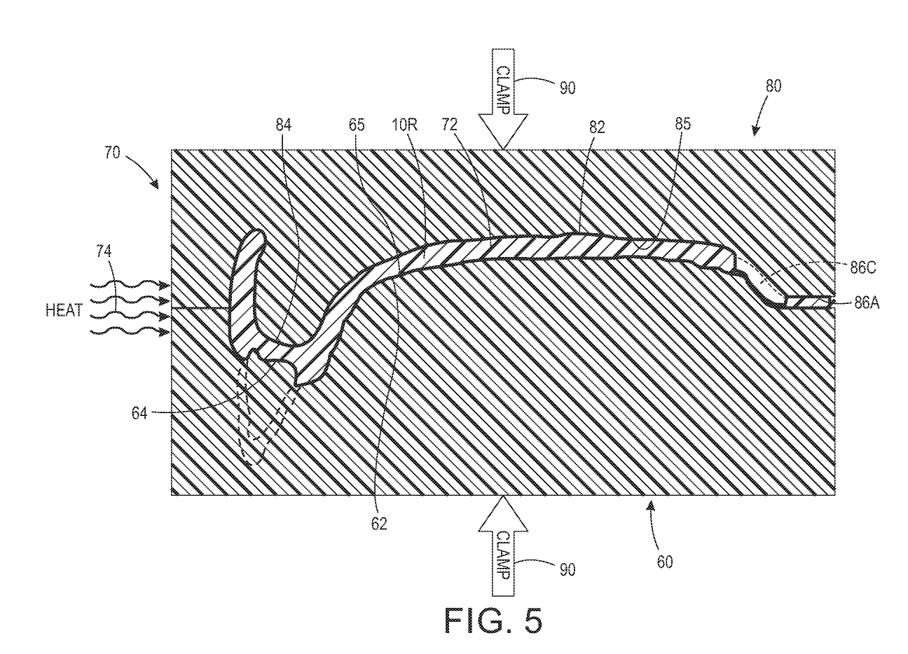

FIGS. 2A, 2B, and 2C depict respective side cross-sectional, perspective, and top views of a bottom mold 60 for making the denture base of FIGS. 1A and 1B; and FIGS. 3A, 3B, and 3C depict respective side cross-sectional, perspective, and bottom views of a top mold 80 for making the denture base of FIGS. 1A and 1B. When bottom mold 60 is joined to top mold 80, the respective opposed mold contours 61 and 81 form a cavity corresponding to the shape of the denture base 10, which may be used to mold the denture base 10, as will be explained subsequently.

Referring to FIG. 2A, the outline of the denture 2 to be fabricated is shown in dotted line format with respect to the bottom mold 60, including the denture base 10 and denture teeth 20. Referring also to FIGS. 2B and 2C, the bottom mold 60 includes a mold contour 61 comprised of a palate region 62 and a tooth socket region 64, which comprises protrusions that will mold the corresponding tooth sockets 12 in the denture base 10.

Referring to FIG. 3A, the outline of the denture 2 to be fabricated is shown in dotted line format with respect to the top mold 80. Referring also to FIGS. 3B and 3C, the top mold 80 includes a mold contour 81 comprised of a palate region 82 and a gum region 84, which comprises a protrusion that will mold the portion of the denture base 10 that will contact the patient's gum when the denture is fitted to the patient. The top mold 80 is further comprised of sprues 86A, 86B, and 86C, which are channels formed in the bottom wall 87 extending from the outer sidewall 88 of the mold 80 to the cavity of the mold contour 81. In the denture base molding, liquid denture base material is delivered through the sprues into the mold cavity formed by the opposed mold contours 61 and 81. It will be apparent that the sprues 86A-86C may be provided in the bottom mold 60 in order to achieve the same result. Additionally, sprue pathways other than those depicted in FIGS. 3B and 3C may be used.

Referring to FIG. 4, the bottom mold 60 is removably joined to the top mold 80 by a clamp 90 or other suitable fixturing (not shown). The joined molds 60 and 80 form the mold cavity 69 within which the denture base 10 is molded.

As described previously, in certain embodiments, the bottom and top molds 60 and 80 may be fabricated using 3D printing. Each of the molds 60 and 80 may be printed with a rigid inelastic support material, and a thin elastomeric material. FIG. 2A depicts bottom mold 60 comprising rigid material 63 and thin elastomeric material 65, and FIG. 3A depicts top mold 80 comprising rigid material 83 and thin elastomeric material 85. Suitable compounds for rigid support materials 63 and 83 include, without limitation, acrylonitrile butadiene styrene (ABS) plastic and polypropylene. Examples of commercial formulations of suitable materials are “Digital ABS” materials and DurusWhite RGD430 Simulated Polypropylene Material, both of which are manufactured and sold by Stratasys, Inc. of Eden Prairie, Minn., and used in the company's line of fused deposition modeling (3D printing) machines. Suitable compounds for thin elastomeric materials 65 and 85 include modified rubber or rubber like materials, such as the commercial formulation “Objet Tangoplus FLX930” acrylic compound, also manufactured and sold by Stratasys, Inc.

The thin elastomeric materials 65 and 85 may be 3D printed at a thickness of about 20 to 100 thousandths of an inch thick. The materials 65 and 85 function as mold release linings, in that they are selected so as to not adhere to the denture base material that is molded and cured in the cavity formed between the molds 60 and 80.

Referring to FIG. 5, mold assembly 70 comprised of joined molds 60 and 80 is placed in a fixture (not shown), and a source (not shown) of fluid synthetic denture base material is connected to inlet sprue 86A. The fluid synthetic denture base material is injected into the denture base mold cavity 72. The source of fluid synthetic denture base material may be a polymer extruding and fluid delivery system as is used in various injection molding processes. Such a system may include an extruder to shear, compress, and melt the polymer into a liquid phase, and/or a positive displacement pump such as a gear pump, a progressing cavity pump, a piston pump, or a diaphragm pump, a pulsation dampener, and various conduits, including a conduit connected to the inlet sprue 86A for delivery of the fluid synthetic denture base material thereto.

After the mold cavity 72 has been completely filled with injected fluid synthetic denture base material, heat 74 may be applied to the mold assembly 70 from a heat source (not shown). The heat 74 will be conducted by the molds 60 and 80 into the fluid synthetic denture base material in the mold cavity 72, causing it to cure into solid synthetic denture base material.

In certain embodiments of the method, and of the denture made by the method, the fluid synthetic denture base material is liquid polymethylmethacrylate (PMMA), which is formulated with a dye or pigment that provides a pink flesh-tone that is characteristic of the appearance of natural gums. The liquid PMMA is injected under pressure through the sprues 86A, 86B, and 86C into the mold cavity 72 and is then polymerized into solid denture base material. In certain embodiments, the PMMA may self-polymerize without the provision of heat.

In other embodiments, heat 74 may be provided to accelerate the polymerization of the PMMA to solid denture base material. The direction of the injection molding is important relative to the heating source which controls polymerization to compensate for shrinkage.

In the instant method, as shown in FIG. 5, injection of the denture base material occurs at the posterior portion of the denture base 10 and the heat 74 is provided such that the temperature gradient from warmer to colder is from the anterior portion to the posterior portion of the denture base 10. The Applicant believes that this configuration provides certain advantages in fabricating the denture base 10. Without wishing to be bound to any particular theory, the Applicant believes that the temperature gradient (from warmer anterior to colder posterior) being in the opposite direction of the flow of liquid PMMA into the mold cavity 72 is beneficial because such a temperature gradient causes the PMMA to polymerize from the anterior region toward the posterior region of the denture base 10. PMMA is known to shrink between about 3 to 8% during polymerization. Thus with shrinkage occurring over this range, due to the temperature gradient that is provided by the heat source located posterior, shrinkage of the denture base 10 occurs sooner at the posterior of the mold cavity 72, and later at the anterior of the mold cavity 72. During such sequential shrinkage from posterior to anterior, the continuous injection pressure that is maintained by the fluid injection source at the posterior portion continues to feed the regions that shrink sooner, so that the resulting fully polymerized denture base 10 is free of porosity and is a dense material that will resist moisture absorption and bacteria growth.

In certain embodiment (not shown), the bottom and top molds 60 and 80 may be designed so that each of them is printed in several sections that are connected with “support” material. Such mold designs allow the respective sections to be separated individually by first removing the “support” material with a blasting medium (water) or heated to dissolve the “support” material. This feature of the mold(s) may be important when the mold(s) has undercuts. Dentures typically have undercuts formed in the denture bases to help retention in the mouth. Thus molds that enable the formation of a denture base with undercuts are advantageous.

In the field of plastic injection molding, a part with undercuts may require a tool that is designed in sections that may slide apart after the injection step. Likewise, the FDM printed molds of the present disclosure may need to slide apart in sections so that parts of the mold that reside in undercuts can be removed from the denture base without damaging the denture base.

In an alternate embodiment (not shown) the bottom and top molds 60 and 80 may be formed as a unitary mold, i.e. a one piece mold. In such a single mold approach made by 3D printing, it is very difficult to form a mold cavity by printing layers of only the mold material. Instead, two materials are printed. The mold material is printed in non-cavity locations, and the mold cavity is filled with a dissolvable or erodable “support” material. In that manner, the areas of the mold material that bound upper portions of the mold cavity may be printed upon the support material at the upper mold cavity boundaries. When 3D printing of the entire single piece mold is finished, the dissolvable support material is flushed out using high-pressure water as a solvent or using an abrading medium such as an abrasive slurry used in optics manufacturing and/or water jet cutting.

The resulting single piece mold may then have the wall of the mold cavity lined with an elastomeric material. The mold cavity has a shape that corresponds to the shape of the denture base. In this method, alternative steps are needed to remove the denture base from the mold. In one embodiment, the mold may be cut or milled away. In another embodiment, the mold may be printed in sections, with dissolvable “support” material printed between sections, so that upon completion of the molding of the denture base, the dissolvable support material may be removed, enabling separation of the mold parts and removal of the denture base from the mold cavity. In one embodiment, the support material may be thermally degradable, such that it loses structural strength upon sufficient heating, thus enabling the separation of the mold parts by heating.

In a further embodiment, parts of the bottom mold 60 and the top mold 80 that include undercuts may have such undercuts 3D printed with a layer of elastomer material that is thicker than the elastomer layer that is printed on the rest of the mold. Such an extra thickness will more easily allow the mold to be removed from the denture base without damaging the undercut areas.

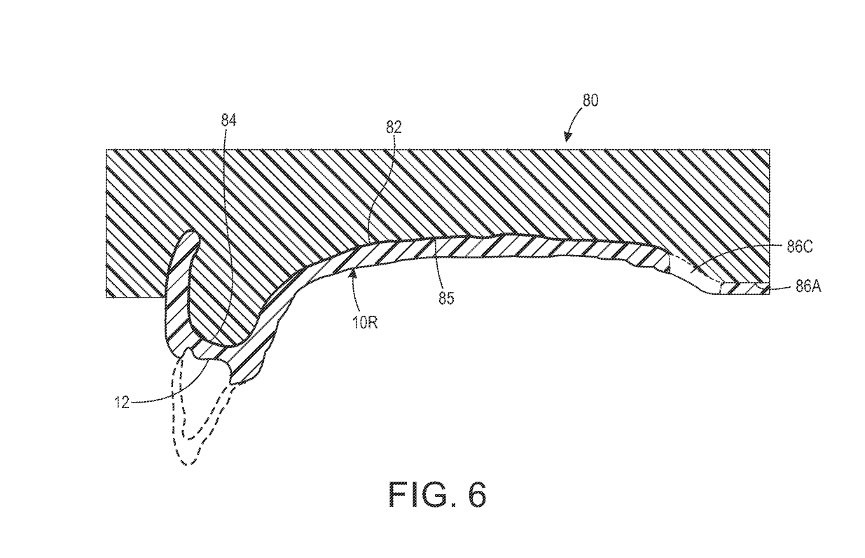

After the molding and curing of the denture base is completed, at least a partial disassembly of the mold assembly 70 is performed, in order to expose the tooth sockets 12 on the tooth side of the denture base, so that the teeth can be subsequently molded and bonded to the denture base. FIG. 6 is a side cross-sectional view depicting the top mold 80 and the molded “rough” denture base 10R remaining adhered thereto, but with the bottom mold 60 having been removed therefrom. In certain embodiments, removal of the bottom mold 60 may be facilitated by heating to make the bottom mold 60 soft and pliable, or at least a portion thereof soft and pliable. Alternatively, a solvent may be used, which wicks into the interface between the bottom mold 60 and the denture base 10R, so that adhesion of the denture base 10R to the mold 60 is reduced.

In certain embodiments, the denture base 10R may be retained in the top mold 80, and the method proceeds with the fabrication of a first tooth mold 100 as depicted in FIG. 8 and described subsequently herein. In such embodiments, the first tooth mold 100 is joined to the top mold 100, and the method proceeds with the delivery of first liquid synthetic tooth material into the tooth cavity of the first tooth mold, as will be described subsequently herein.

In other embodiments, the denture base 10R is also removed from the top mold 80, possibly facilitated by the use of heat and/or a solvent, as described previously for removal of the bottom mold 60. The resulting “rough” denture base 10R is comprised of anterior region 11 (to which synthetic teeth will be bonded), posterior region 13, and sprue region 15, which will be ground away in a finishing step to be described subsequently.

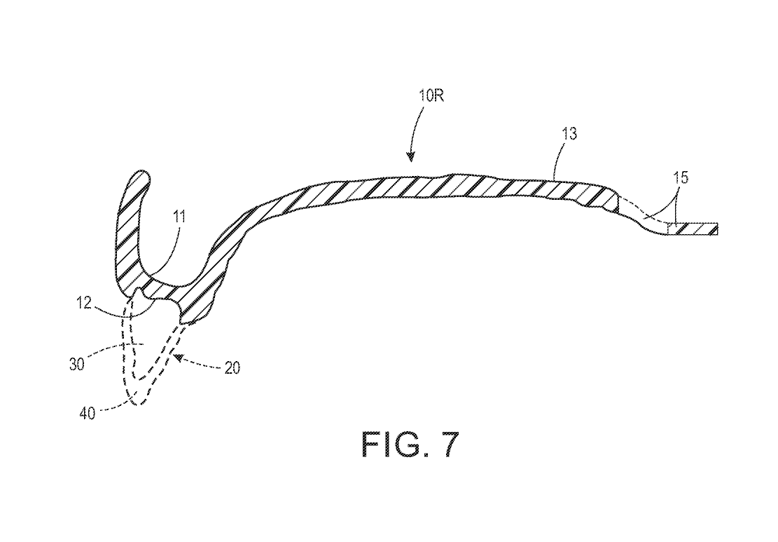

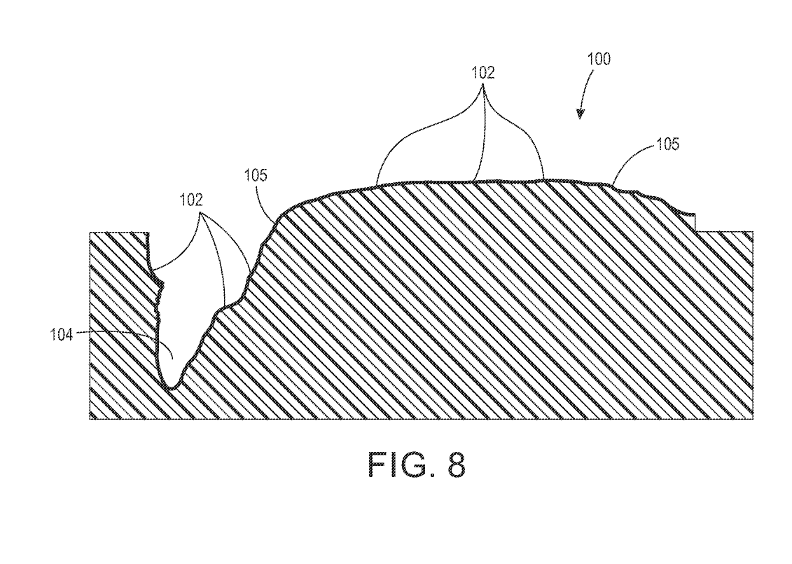

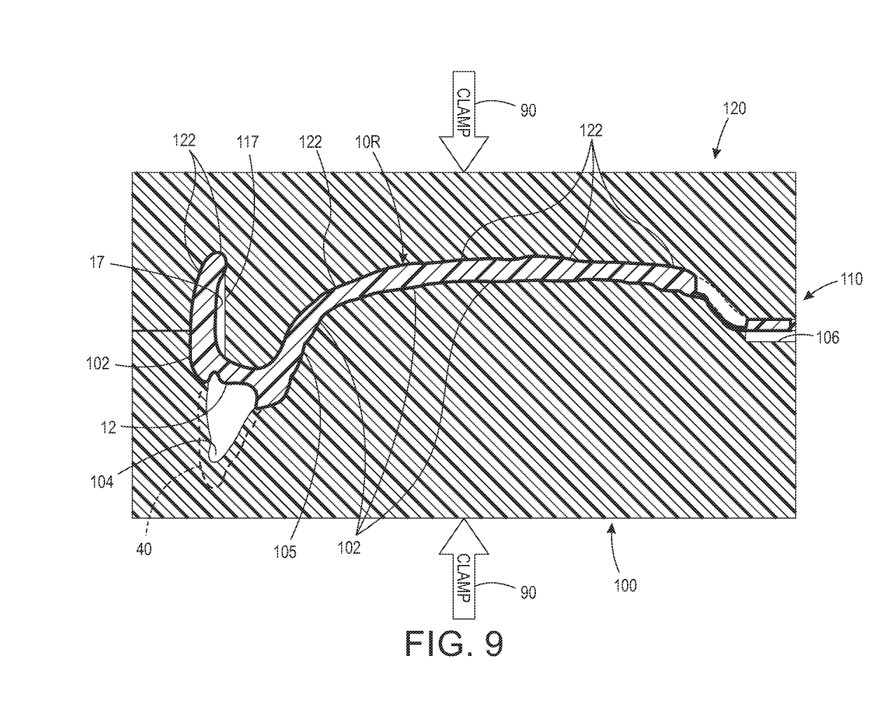

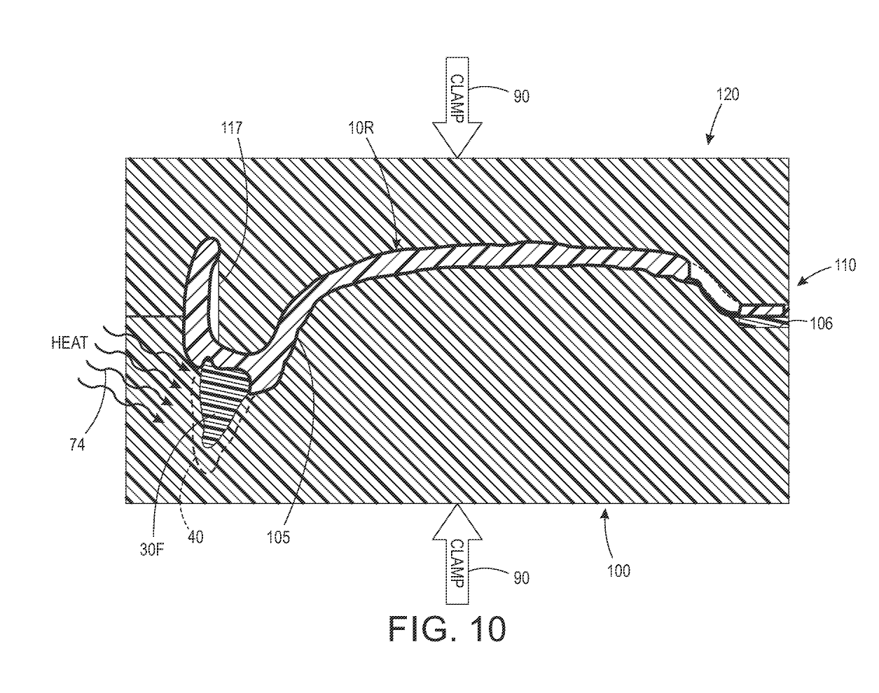

The second main operation commences, which is molding of the denture teeth, with bonding of the teeth to the denture base. In order to mold at least a first portion of the denture teeth, a three-dimensional model of a first bottom denture tooth mold is produced using 3D CAD design software. Additionally, if the rough denture base 10R is separated from the denture base mold 80 as shown in FIG. 7, a new top denture tooth mold may be fabricated. This embodiment of the Applicant's method is depicted in FIGS. 9, 10, 12, and 14-16. As may be done for fabrication of the denture base, the top and bottom tooth molds may be made using a 3D printing process. Thus the custom made “one of a kind” tooth molds for making a denture for a specific patient may be made at low cost. The top and bottom tooth molds will likely be used only once, or at most a few times if a replacement denture is needed.

FIG. 8 is a side cross-sectional view of a first tooth body mold 100 for making at least a first portion the denture teeth of the denture, and FIG. 9 is a side cross-sectional view of a top tooth mold 120 joined to the first tooth body mold 100 of FIG. 8 in preparation for molding at least the first portion the denture teeth of the denture. The first tooth body mold 100 is comprised of a contoured surface 102 that is shaped to correspond to the underside of the rough denture base 100R. The top tooth mold 122 is comprised of a contoured surface 122 that is shaped to correspond to the top side of the rough denture base 10R.

Referring to FIG. 9, the rough denture base 10R is fitted in the top tooth mold 120 with its top surface in contact with the matching contoured surface 122. In embodiments in which the denture base 10R has a concave region 17, the top tooth mold 120 may be provided with a vertical side wall 117 in order to facilitate the fitting of the denture base 10R into the top tooth mold 120. The first bottom tooth mold 100 is then joined to the top tooth mold 120 with the underside of the denture base 10R in contact with the matching contoured surface 102 of the first bottom tooth mold 100. The bottom tooth mold 100 may include a layer of thin elastomeric material 105 to function as a mold release lining, as described previously for the bottom and top denture base molds 60 and 80. No elastomeric layer is needed on the contoured surface of the top mold 120, because no fluid synthetic tooth material will be in contact with the top mold 120 during the tooth molding process.

The bottom tooth mold 100 is further comprised of a tooth cavity 104. When the bottom tooth mold 100 is joined to the top tooth mold 120 to form a mold assembly 110 with the rough denture base 10R contained therein, the tooth sockets 12 of the denture base 10R, together with the tooth cavity 104, form an overall tooth mold cavity for molding of at least a first portion of the denture teeth. Although the side cross-sectional view of FIG. 9 depicts only a single incisor tooth portion of the overall tooth mold cavity, it is to be understood that the overall tooth mold cavity is formed for the entire set of denture teeth, extending from the left side to the right side of the denture, i.e. molars-canine-incisors-canine-molars.

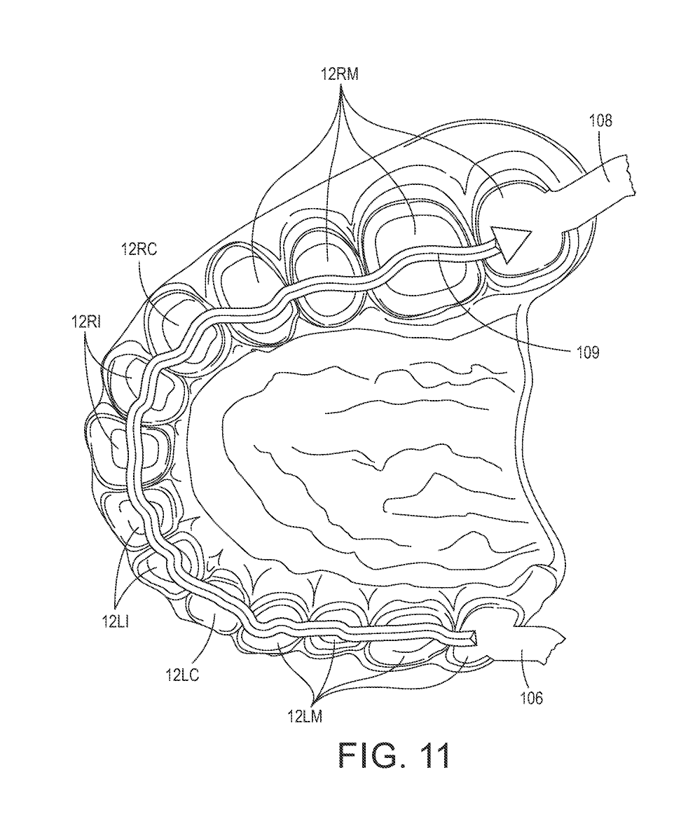

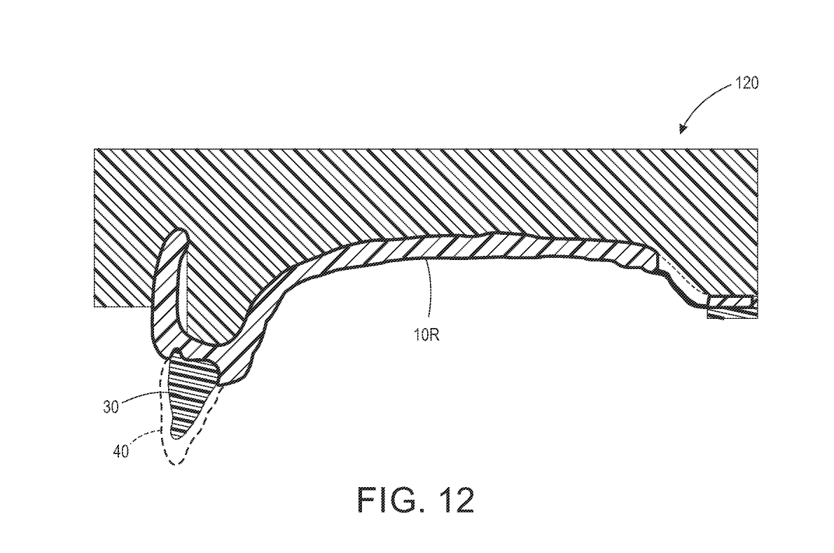

Referring to FIGS. 9 and 10, mold assembly 110 comprised of joined molds 100 and 120 is placed in a fixture (not shown), and a source (not shown) of first fluid synthetic tooth material is connected to inlet sprue 106. The first fluid synthetic denture tooth material is injected into the denture tooth mold cavity 104. The source of the first fluid synthetic denture tooth material may be a fluid delivery system as is used in various injection molding processes. Referring also to FIG. 11, the flow of fluid tooth material in the mold cavity 104 is shown schematically. Fluid tooth material enters the cavity through inlet sprue 106, and fills left molar tooth sockets 12LM, left canine socket 12LC, left incisor sockets 12 LI, right incisor sockets 12RI, right canine socket 12RC, and right molar tooth sockets 12RM, and exits through outlet sprue 108 (not shown in FIGS. 9 and 10), as indicated by arrow 109.

After the tooth mold cavity 104 has been completely filled with injected first fluid synthetic tooth material, heat 74 may be applied to the mold assembly 110 from a heat source (not shown). The heat 74 will be conducted by the mold 100 into the fluid synthetic tooth material 30F in the mold cavity 104, causing it to polymerize into first solid synthetic denture tooth material. This first synthetic tooth material may be a tooth-colored methacrylate material, which is typically darker in color hue and less translucent compared to other outer layer(s) of artificial and natural teeth. In the tooth material curing process, the denture base 10R and first layer of teeth 30F formed in the mold cavity 104 are chemically cross-linked to each other in a polymerization process that is similar to that described previously for forming the denture base 10R. Referring again to FIG. 10, heating source (not shown) may be positioned proximate to the anterior portion of the tooth cavity 104, while the injection of first fluid synthetic tooth material is provided continuously into the posterior portion of the tooth cavity 104. Such a practice compensates for any shrinkage of the first fluid synthetic tooth material due to some initial curing that occurs during fluid synthetic material delivery.

In the embodiment depicted in FIG. 11 and described previously, the flow of first synthetic fluid tooth material is first injected at the sprue 106 proximate to one posterior end of the denture teeth. The flow of first synthetic fluid tooth material occurs as indicated by arrow 109, causing air in the tooth mold cavity 104 to be expelled through the sprue 108 located at the other posterior end of the denture teeth. In certain embodiments, after sufficient synthetic fluid tooth material is expelled from the cavity 104, and air bubbles cease to be present in the outflowing first synthetic fluid tooth material, a second synthetic tooth material delivery device (not shown) may be connected to the posterior sprue 108. Both synthetic tooth material injection devices may then be activated to maintain first fluid synthetic tooth material flowing into both posterior ends of the tooth mold cavity 104 as the heat source positioned at the anterior causes the fluid synthetic tooth material to shrink as it is polymerized.

In certain embodiments, the tooth cavity 104 that is provided in the bottom tooth mold 100 may be formed to correspond to the shape of the full sized set of teeth, an incisor 40 of which is indicated in FIGS. 9 and 10 in dotted line format. In such an embodiment, the entire set of teeth for the denture may be made in a single tooth molding step. This results in the fabrication of a denture at minimum cost. However, molding the teeth of a single synthetic tooth material in a single step may have the disadvantage of the denture teeth not having a natural appearance with subtle shade variations and a translucent appearance.

Typically, however, denture teeth are made from multiple layers of shaded plastic (such as PMMA), composite material or porcelain. The denture teeth made in the present method may be comprised of at least two layers of such materials. If denture cost is not the highest priority, it is preferable to provide a denture with natural appearing teeth. Making such a denture may be accomplished by molding a first portion of the teeth with a first synthetic tooth material as has been described above, and then molding the remaining portion of the teeth with a second synthetic tooth material that simulates natural tooth enamel, as will now be described.

FIG. 12 depicts a side cross-sectional view of the top mold 120 of FIG. 10 with the first tooth body mold 100 having been removed therefrom, and the molded rough denture base 10R with partially formed denture teeth 30 remaining adhered thereto. In certain embodiments, removal of the bottom mold 100 may be facilitated by heating to make the bottom mold 100 soft and pliable, or at least to make the elastomer layer 105 soft and pliable.

In order to mold at the second (enamel) portion 40 of the denture teeth, a three-dimensional model of a second bottom denture tooth mold is produced using 3D CAD design software. As may be done for fabrication of the denture base, the top and bottom tooth molds may be made using a 3D printing process.

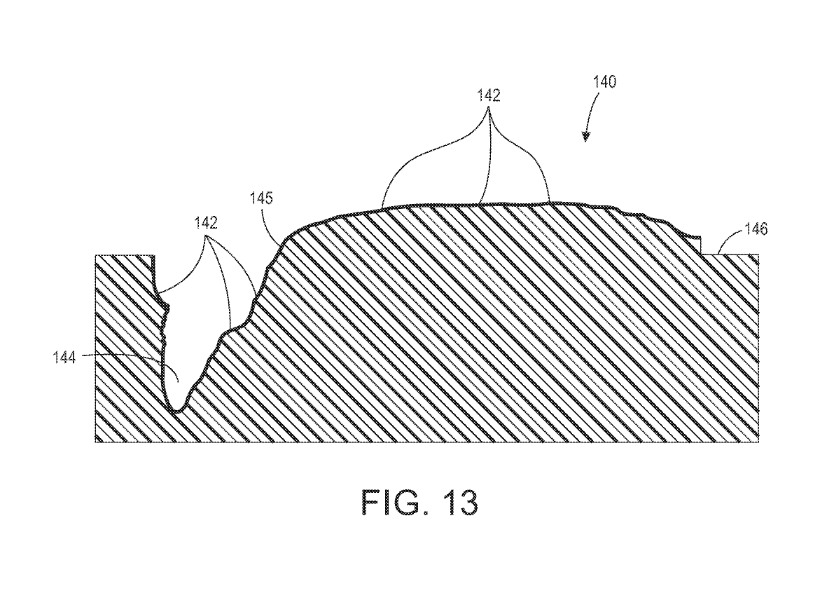

FIG. 13 is a side cross-sectional view of a second tooth body mold 140 for making the second portion the denture teeth of the denture. The second tooth body mold 140 is comprised of a contoured surface 142 that is shaped to correspond to the underside of the rough denture base 100R, a tooth cavity 144, and an elastomeric layer 145.

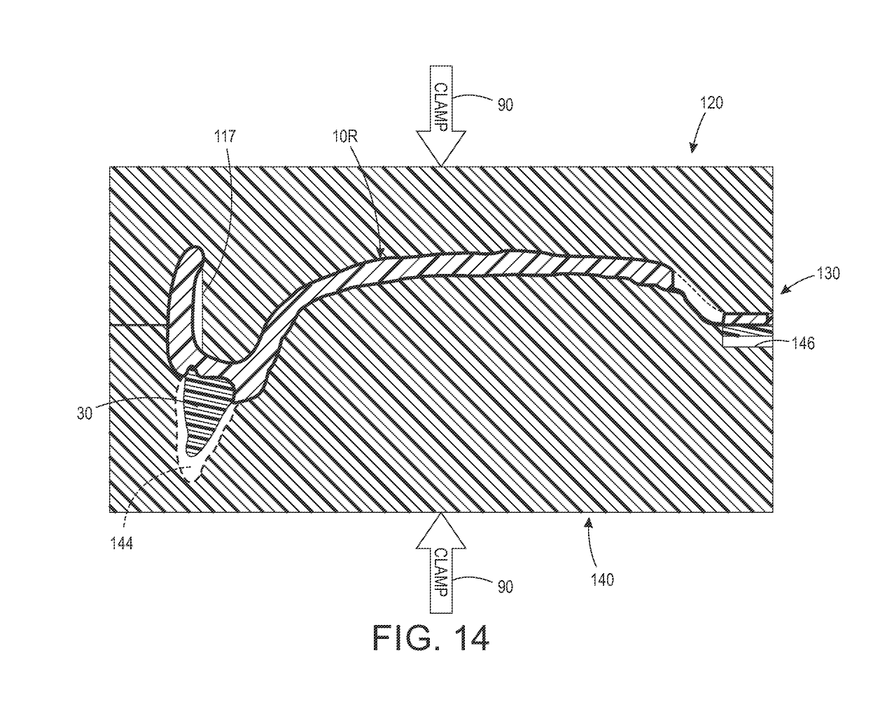

Referring to FIG. 14, the rough denture base 10R remains fitted in the top tooth mold 120. The second bottom tooth mold 140 is then joined to the top tooth mold 120 with the underside of the denture base 10R in contact with the matching contoured surface 142 of the second bottom tooth mold 140. In the mold assembly 130 with the rough denture base 10R contained therein, the partially molded teeth 30, together with the tooth cavity 144, form an overall tooth mold cavity for molding the second portion of the denture teeth. Although the side cross-sectional view of FIG. 14 depicts only a single incisor tooth portion of the overall second tooth mold cavity, it is to be understood that such mold cavity is formed for the entire set of denture teeth, extending from the left side to the right side of the denture.

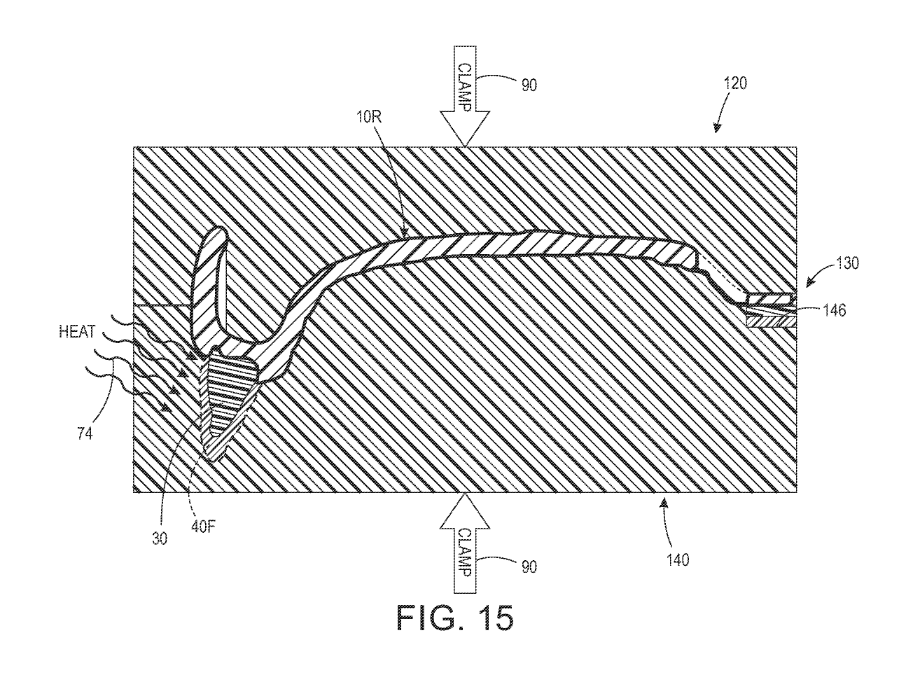

Referring to FIGS. 14 and 15, mold assembly 130 comprised of joined molds 140 and 120 is placed in a fixture (not shown), and a source (not shown) of second fluid synthetic tooth material is connected to inlet sprue 146. The second fluid synthetic denture tooth material is injected into the denture tooth mold cavity 144. The source of the second fluid synthetic denture tooth material may be a fluid delivery system as is used in various injection molding processes. The flow of second synthetic fluid tooth material in the mold cavity 144 is similar to that shown schematically in FIG. 11 for the first synthetic fluid tooth material.

After the tooth mold cavity 144 has been completely filled with injected second fluid synthetic tooth material, heat 74 may be applied to the mold assembly 130 from a heat source (not shown). The heat 74 will be conducted by the mold 140 into the fluid synthetic tooth material 40F in the mold cavity 144, causing it to polymerize into second solid synthetic denture tooth material. In certain embodiments second synthetic tooth material may be a shaded material made from a tooth-colored methacrylate. The second layer of tooth material 40 is typically a lighter shade and more translucent as compared to the first layer 30 of tooth material, and has the appearance of the enamel layer of natural teeth. Additionally, if the layer 40 of tooth material is to be the final outer layer of tooth material, a material which has the hardness and wear resistance comparable to the enamel layer of natural teeth is selected. Suitable materials for outer layer 40 include cross-linked methyl-methacrylates and glass-filled composite resins.

In the process of curing second tooth material 40, the first layer of teeth 30 and the tooth material 40F formed in the mold cavity 144 may be chemically cross-linked to each other in a polymerization process that is similar to that described previously for forming the denture base 10 and first tooth layer 30. Referring again to FIG. 15, a heating source (not shown) may be positioned proximate to the anterior portion of the tooth cavity 144, while the injection of second synthetic tooth material is provided continuously into the posterior portion of the tooth cavity 144. A second synthetic fluid tooth material delivery device (not shown) may be connected to an outlet sprue (not shown), with both synthetic tooth material injection devices being activated to maintain second fluid synthetic tooth material flowing into both posterior ends of the tooth mold cavity 144 during heating, as described previously for the molding and curing of the first tooth material 30.

If the second layer 40 of tooth material is not the final enamel layer of the denture teeth 20, additional layers of teeth can be made by repeating the molding process is a manner similar to that described for first and second tooth layers 30 and 40.

In certain embodiments, a heat-treating process may be employed to fully polymerize the teeth 20 and denture base 10. Heat-treating may be beneficial because it may increase the density of polymer networks in the teeth 20 and base 10 via additional cross-linking, thereby improving strength and wear resistance. The heat treating may also improve the chemical bond of the teeth to the denture base. The improved chemical bond is believed to decrease the likelihood of the artificial teeth detaching from the denture base (referred as a “pop-out”), and the formation of dark demarcation lines around the junction of the artificial teeth and artificial gingiva due to bacterial growth. (The latter problem is often found in dentures made with porcelain artificial teeth of the current art, because there is no chemical bond between the denture base and such porcelain teeth). Heat treating may also reduce the residual monomer content of the teeth 20 and base 10, which may reduce patient sensitivity to the denture. The heat treating may be done with the finished denture 10R contained in the mold assembly 130, or it may be done after removal of the denture 10R from the mold assembly 130.

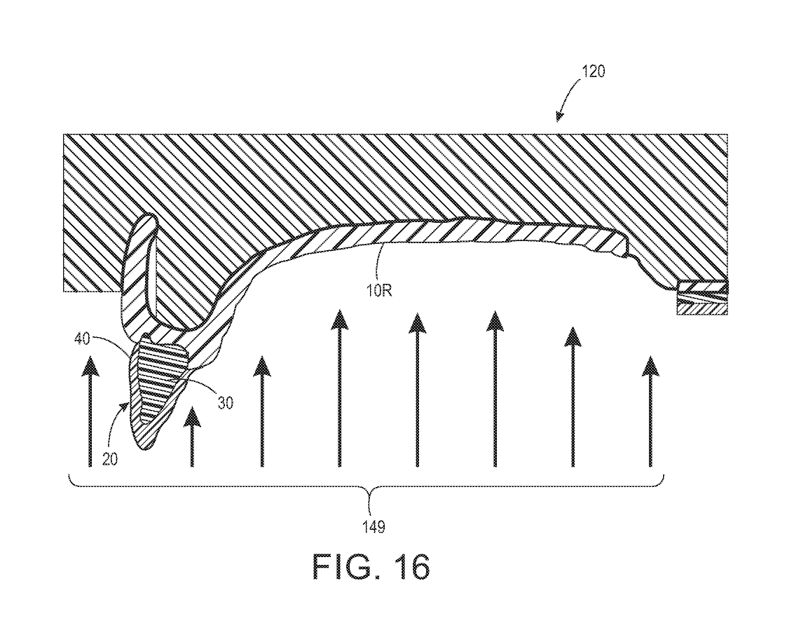

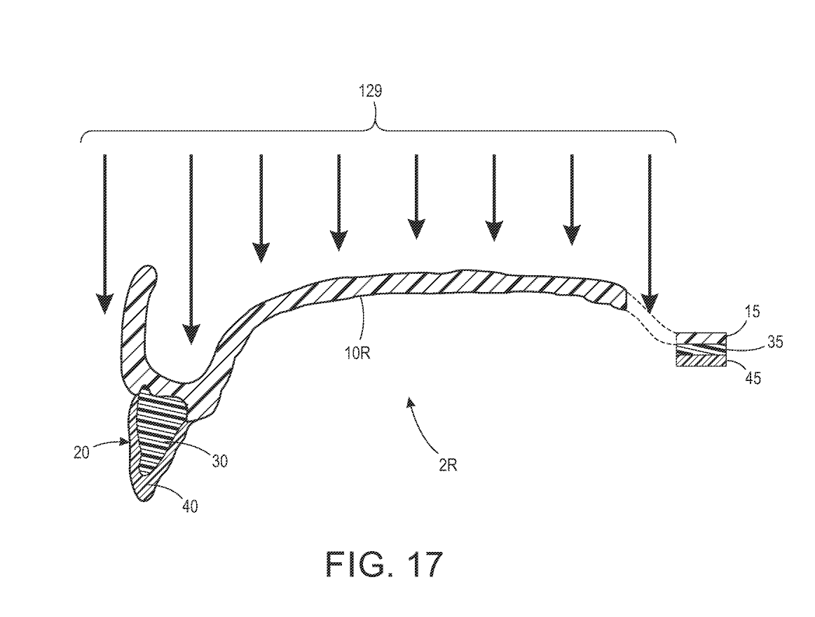

When the layer 30 or layers 30 and 40 (and any additional layers) of teeth are completed, the molds 140 and 120 are removed. In certain embodiments, the mold 140 may be removed by delivery of a blasting medium (not shown) as indicated by arrows 149 in FIG. 16, and the mold 120 may be removed by delivery of a blasting medium (not shown) as indicated by arrows 129 in FIG. 17.

The rough denture 2R of FIG. 17 may then be finished by trimming and/or grinding to remove the sprue materials 15, 35, and 45 using a small high speed milling tool or other suitable device. The teeth 20 of the denture may be polished in a conventional manner, such as by using wet pumice on a rag wheel, and then using a high-shine buffing compound to produce the finished denture 2 depicted in FIGS. 18A and 18B.

In certain embodiments, the fluid synthetic denture base and tooth materials may contain solid particles and/or fibers, such as pigments for coloration, and/or particles or fibers to improve wear resistance and structural strength of the artificial teeth. The fluid synthetic denture base and tooth materials may be formulated as liquid/solid dispersions. The fluid synthetic denture base and tooth materials may be formulated as hot melt materials that are delivered into the cavities in a molten state and then solidify.

The present methods may also be used to make a trial denture. In a first step, a denture base is molded from a suitable material such as methacrylate, typically of a pink flesh-tone color as described herein. This denture base may be formed in a first set of FDM printed molds. These molds may then be removed from the denture base. In a second step, the denture base may then be fitted between a second set of FDM printed molds to create a first mold cavity, which may then filled by a pink-colored wax that is relatively soft at room temperature. The bottom mold of the assembly is designed to form the layer of wax approximately 1 to 3 millimeters in thickness in and around the denture tooth sockets of the denture base.

In a third step, bottom wax-cavity mold is removed, and the denture base and thin wax layer on the tooth sockets retained in the top mold is fitted with another bottom mold that forms a tooth mold cavity. The cavity may be then filled by fluid synthetic tooth material made from tooth-colored methacrylate. The finished trail denture, comprising a denture base, a thin wax layer over the tooth sockets, and the denture teeth embedded in the wax layer is removed from the molds. Finishing steps to remove sprues are performed as described previously, to produce the finished trial denture.

The tooth sockets containing wax are preferred because they enable a dentist to adjust the position of the teeth, if necessary, in order to optimize occlusion or aesthetics of the teeth in a trial fitting of the denture. Dentists are accustomed to making adjustments to trial dentures, so this method is consistent with present practice. In addition, the teeth can be made from single or multiple layers of tooth-colored methacrylate or other suitable polymers so that the trial denture will look exactly like or similar to the finished denture, thereby increasing the likelihood of patient acceptance at the final delivery appointment.

Although the molds disclosed herein have been described as being made by fused deposition modeling (FDM), also known as 3D printing. other additive manufacturing processes may be used for mold fabrication, including but not limited to selective laser melting (SLM), selective laser sintering (SLS), selective heat sintering (HLS), stereolithography (SLA), robocasting, electron beam freeform fabrication (EBF³), direct metal laser sintering (DMLS), electron bean melting (EBM), binder jetting or other jetting processes, and digital light processing (DLP) of photopolymers, ceramics, and metals. For each mold, a 3D model may be uploaded to a computer controlled machine that makes part by performing the particular additive manufacturing process.

It is to be understood that while the present disclosure has been set forth as methods, an apparatus, and a kit for making a denture, the methods, apparatus, and kit are not limited to only such an article. The instant method and apparatus are applicable to other dental prostheses such as partial denture prostheses, occlusal splints, nightguards, orthodontic appliances, crowns, bridges, as well as for the fabrication of other medical prostheses comprising 3D printed molds, wherein the first material is molded to form a base for receiving a fluid material and a second mold used for receiving a fluid second material, curing it into solid first material, to make the medical prosthesis or a portion thereof.

It is, therefore, apparent that there has been provided, in accordance with the present disclosure, a method, apparatus, and kit for the manufacturing of a dental prosthesis, and a denture comprising a base and a plurality of teeth. Having thus described the basic concept of the invention, it will be rather apparent to those skilled in the art that the foregoing detailed disclosure is intended to be presented by way of example only, and is not limiting. Various alterations, improvements, and modifications will occur to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims.

1. A method of making a denture comprised of a denture base and a plurality of denture teeth joined to the base, the method comprising:
a) creating three-dimensional models of a top denture base mold, a bottom denture base mold, and a first denture tooth mold;
b) fabricating the top and bottom denture base molds, and the first denture tooth mold;
c) removably joining the bottom denture base mold to the top denture base mold to form a mold cavity defining the shape of the denture base;
d) injecting fluid synthetic denture base material into the denture base mold cavity and curing the denture base material to form the denture base;
e) removing the bottom denture base mold from the top denture base mold, while leaving the denture base in the top denture base mold;
f) removably joining the first denture tooth mold to the top denture base mold to form a first tooth mold cavity bounded by the first denture tooth mold and the denture base and defining the shape of at least a portion of the denture teeth;
g) injecting fluid first synthetic denture tooth material into the first tooth mold cavity and curing the first denture tooth material to form at least the portion of the denture teeth joined to the denture base; and
h) removing the first denture tooth mold from the top denture base mold, while leaving the denture base and at least the portion of the denture teeth in the top denture base mold.

2. The method of claim 1, wherein denture base and the first denture tooth mold form a mold cavity defining the entire denture teeth, and the method further comprises removing the denture base and denture teeth from the top denture base mold joined together as the denture.

3. The method of claim 1, further comprising creating a three-dimensional model of a second denture tooth mold, fabricating the second denture tooth mold, removably joining the second denture tooth mold to the top denture base mold to form a second tooth mold cavity defining the shape of second synthetic denture tooth material of the denture teeth, injecting fluid second synthetic denture tooth material into the second tooth mold cavity and curing the fluid second synthetic denture tooth material to form the second synthetic denture tooth material joined to the first synthetic denture tooth material, and removing the second denture tooth mold from the top denture base mold, and removing the denture base, first and second synthetic denture tooth materials from the top denture base mold joined together as the denture.

4. The method of claim 3, wherein the second synthetic denture tooth material is synthetic denture tooth enamel material.

5. The method of claim 1, further comprising removing molding sprues from the denture and polishing the denture base and the denture teeth to produce a finished denture.

6. The method of claim 1, wherein the top denture base mold, the bottom denture base mold, and the denture tooth mold are made by at least one additive manufacturing process.

7. The method of claim 1, wherein at least one of the curing the fluid synthetic denture base material, and curing the fluid synthetic denture tooth material is performed by heating the at least one of the fluid synthetic materials.

8. The method of claim 1, wherein at least one of the curing the fluid synthetic denture base material, and curing the fluid synthetic denture tooth material is performed by self-curing the at least one of the fluid synthetic materials.

9. The method of claim 1, wherein the curing the denture tooth material to form the denture teeth joined to the denture base chemically bonds the denture teeth to the denture base.

10. The method of claim 1, wherein the top denture base mold is comprised of an elastomeric layer formed on a bottom portion of the top denture base mold that forms a top portion of the mold cavity defining the shape of the denture base, and the bottom denture base mold is comprised of an elastomeric layer formed on a top portion of the bottom denture base mold that forms a bottom portion of the mold cavity defining the shape of the denture base.

11. The method of claim 1, wherein the denture tooth mold is comprised of an elastomeric layer formed on a top portion of the denture tooth mold that forms a portion of the mold cavity defining the shape of the denture teeth.

12. The method of claim 1 wherein at least one of the top denture base mold, bottom denture base mold, and denture tooth mold is comprised of a first rigid part joined to a second rigid part by a layer of soluble material disposed therebetween.

13. The method of claim 1, further comprising heat treating the denture base and plurality of teeth.

14. The method of claim 1, wherein curing the first fluid synthetic denture base material is performed by heating the first fluid synthetic denture base material.

15. The method of claim 1, wherein solidifying the first fluid synthetic denture base material is performed by self-curing first fluid synthetic denture base material.

16. The method of claim 1, wherein solidifying the first fluid synthetic denture tooth material is performed by heating the first fluid synthetic denture tooth material.

17. The method of claim 1, wherein solidifying the first fluid synthetic denture tooth material is performed by self-curing first fluid synthetic denture tooth material.

18. The method of claim 1, wherein the denture is defined by a digital three-dimensional model, and wherein the fabricating the top denture base mold, bottom denture base mold, and denture tooth mold are performed based upon data from the three-dimensional model.

19. The method of claim 18, further comprising making a trial denture, fitting the trial denture to a patient, scanning the fitted trial denture to obtain scanned denture data, and using the scanned denture data to produce the digital three-dimensional model.

20. A method of making a denture comprised of a denture base and a plurality of denture teeth joined to the base, the method comprising:
a) creating three-dimensional models of a top denture base mold, a bottom denture base mold, and a top denture tooth mold and a first bottom denture tooth mold;
b) fabricating the top and bottom denture base molds, and the top denture tooth mold and first bottom denture tooth mold;
c) removably joining the bottom denture base mold to the top denture base mold to form a mold cavity defining the shape of the denture base;
d) injecting fluid synthetic denture base material into the denture base mold cavity and curing the denture base material to form the denture base;
e) removing the bottom denture base mold and the top denture base mold from the denture base;
f) removably joining the top denture tooth mold and first bottom denture tooth mold with the denture base contained therebetween to form a first tooth mold cavity bounded by the first bottom tooth mold and the denture base and defining the shape of at least a portion of the denture teeth;
g) injecting fluid first synthetic denture tooth material into the first tooth mold cavity and curing the first denture tooth material to form at least the portion of the denture teeth joined to the denture base; and
h) removing the first bottom denture tooth mold from the top denture tooth mold, while leaving the denture base and at least the portion of the denture teeth in the top denture base mold.

21-29. (canceled)
